(19) United States
(12) Patent Application Publication
(10) Pub. No.: US 2022/0021228 A1
(43) Pub. Date: Jan. 20, 2022

(54) SPHERICAL MAGNETIC CHARGING CABLE

(71) Applicant: DONGGUAN CHENXUN ELECTRONICS CO., LTD., DONGGUAN (CN)

(72) Inventors: RUMENG YAN, SHAOYANG (CN); FUJUN ZENG, FENGCHENG (CN)

(21) Appl. No.: 16/929,135

(22) Filed: Jul. 15, 2020

(51) Int. Cl. H02J 7/00; H01R 13/62; H01R 35/04

(52) U.S. Cl. CPC H02J 7/0045; H01R 35/04; H01R 13/6205

(57) ABSTRACT

The invention discloses a spherical magnetic charging cable and its assembling process, including a wire, a net tail, a contact spring pin, and a metal butt joint. A first shell is nested on the outer end of the wire, and the net tail is arranged through the inside of the first shell, and the net tail is connected with the wire. A light-emitting PCB is nested inside the net tail, and the light-emitting PCB is connected to the end of the wire. A magnet is arranged at the outer end of the net tail, and a contact spring pin is nested at the middle end of the magnet. A plurality of spring plates are fixedly connected to the outside of the PCB sheet, and these spring plates are connected to the light-emitting PCB, and the spring plates and the outer sides of the PCB sheet are nested with an encapsulation.

### FIELD

This application relates to the technical field of magnetic charging cables, in particular to a spherical magnetic charging cable.

### BACKGROUND

With the increasing demand for mobile phones, the adaptable plug port charging cable has also become one of the more important items. The traditional port-type charging cable is gradually replaced by the magnetic charging data cable. The magnetic charging line refers to the charging cable that achieves the charging effect through the suction method of the magnet, but the existing spherical magnetic charging cable still has the following defects:

1. Publication No. CN209822918U discloses a spherical magnetic cable with a rotating function. Compared with the conventional ordinary charging cable and the magnetic charging cable, it ensures the normal charging function, and also ensures that the charging cable can be bent to a specified angle at the fracture of the charging cable according to the user's needs, the main improvement point of this charging cable is the ball head, and the original negative electrode is at the magnet. The magnet is easy to heat during the work process, which is easy to reduce the service life of the component, and there are certain defects in use;

2. The existing spherical magnetic charging cable does not have good contact continuity during the angle adjustment process, which leads to the occurrence of undesirable phenomena such as power outage during its use, which inconveniences the user's operation.

In response to the above-mentioned problems, innovative design is urgently needed on the basis of the original magnetic charging cable structure.

### SUMMARY

The purpose of the present application is to provide a spherical magnetic charging cable and its assembly process to solve the undesirable phenomena mentioned in the background art, such as easy to generate large heat during work, and easy to reduce the service life of components during long-term heating, and not having good contact continuity during the angle adjustment process, which in turn leads to outage during its use, etc.

In order to achieve the above object, the present application provides the following technical solution: A spherical magnetic charging cable, including a wire, a net tail, a contact spring pin, and a metal butt joint, a first shell is nested on the outer end of the wire, the net tail is arranged through the inside of the first shell, and the net tail is connected with the wire, and a light-emitting PCB is nested inside the net tail, and the light-emitting PCB is connected to the end of the wire, and the outer end of the net tail is provided with a magnet, and the contact spring pin is nested at the middle end of the magnet, and a PCB sheet is fixedly connected to the outer end of the contact spring pin, and a plurality of spring plates are fixedly connected to the outer side of the PCB sheet, and the spring plates are connected with the light-emitting PCB, and the spring plates and the outer side of the PCB sheet are nested with an encapsulation, the spring plates and the middle end of the light-emitting PCB are nested with a plug shaft, and the plug shaft is connected with the net tail, a second shell is nested on the outer side of the encapsulation, and the second shell is connected with the magnet, and a first plug is nested on the outer end of the magnet, and a mobile terminal is provided on the outer end of the first plug, and a USB socket is provided at the end of the mobile terminal, and at the same time, the USB socket is connected to the first plug, and a magnetic ring is fixedly connected to the outer end of the first plug, and an arc-shaped groove is provided inside the magnetic ring and the metal butt joint is connected to the outer end of the first plug, and the metal butt joint is connected to the magnetic ring.

Preferably, the outer wrap of the wire is nylon, fish wire or flash material, and the wire forms a nested structure with the first shell by the net tail, and the net tail forms a rotating structure with the light-emitting PCB by the plug shaft, and the rotation range of the net tail is 0-180°.

Preferably, the spring plates are made of copper, and the spring plates are symmetrically distributed about the center point of the light-emitting PCB, and the spring plates form a nested structure with the net tail and the light-emitting PCB by the plug shaft, and at the same time, the spring plates and the light-emitting PCB are connected to the outer end of the PCB sheet by the encapsulation.

Preferably, the contact spring pin, the magnet, the magnetic ring and the metal butt joint are all electrodes, and the contact spring pin and the metal butt joint are positive poles, and the magnet and the magnetic ring are negative poles.

Preferably, the first plug is provided with a second plug and a third plug, and the outer end of the first plug is connected to the magnet, and the second plug and the third plug can be provided at the outer ends of the magnets, respectively.

Preferably, the first plug and the second plug form a nested structure with the inner end of the magnet by the metal butt joint, and the second plug and the third plug form a snap-fit structure with the mobile terminal by the USB socket, and the mobile terminal is a mobile phone or a tablet computer.

An assembly process of a spherical magnetic charging wire includes the following steps:
S1: processing of the front part;
a. Put the magnet, contact spring pin, PCB sheet and spring plates into the metallurgical tool, then sequentially weld the magnet with the contact spring pin and the PCB sheet together, and then weld 2 sets of spring plates (5) on the outside of the PCB sheet;
b. Place the welded magnet and its components into the corresponding molds to form the encapsulation;
c. Glue the magnet with the encapsulation and its components to the inside of the nested second shell,
S2: Processing of the rear part;
a. Weld the wire to the outer end of the light-emitting PCB;
b. Put the soldered light-emitting PCB into the corresponding mold to form the encapsulation;
c. Nest the light-emitting PCB with the encapsulation and the wire to the inside of the net tail, and then glued to the inside of the first shell,
S3: Total processing;
a. Fix the semi-finished product of the front part formed by the second shell and the shrapnel and the semi-finished product of the rear part formed by the net tail and the first shell together by the plug shaft;
b. Butt the corresponding first plug with the magnet inside the second shell to form a finished product.

Compared with the prior art, the beneficial effects of the present application are: the spherical magnetic charging cable and its assembly process;

1. A nested magnet is provided, and the original negative pole is designed to be connected to the PCB through the copper spring plate to achieve good contact continuity. The contact spring pin in the middle of the wire end and the contact in the middle of the plug are used as positive poles, and the magnets at both ends are used as negative poles. During the working process, the attraction of the magnet will join the two ends together, thereby allowing current to pass. While ensuring its electrical docking stability, it achieves the effect of angular rotation.

2. The symmetrically distributed spring plates are provided, and a movable structure is set at the docking position on the docking position of the wire end. Through the nesting and docking state between the copper spring plates and the PCB, good contact continuity is achieved. At the same time, the wire end does not generate heat, which ensures the normal realization of the charging function and ensures that the charging cable can be bent to a specified angle at the fracture of the charging cable according to the user's needs.

### BRIEF DESCRIPTION OF THE DRAWINGS

FIG. 1 is a schematic view of a three-dimensional structure of a mobile terminal connection according to the present invention;

FIG. 2 is a schematic view of a three-dimensional structure of a wire according to the present invention;

FIG. 3 is a schematic view of a three-dimensional structure of a first plug according to the present invention;

FIG. 4 is a schematic view of the rotating three-dimensional structure of the first shell according to the present invention;

FIG. 5 is a schematic structural cross-sectional view of a light-emitting PCB according to the present invention;

FIG. 6 is a schematic view of a three-dimensional structure of a lateral rotation of a net tail according to the present invention;

FIG. 7 is a schematic view of a three-dimensional structure of a longitudinal rotation of a net tail according to the present invention;

FIG. 8 is a schematic view of a rotating three-dimensional structure of a net tail rotating according to the present invention;

FIG. 9 is a schematic view of a three-dimensional structure of a net tail splitting according to the present invention;

FIG. 10 is a schematic view of an assembled three-dimensional structure of spring plates according to the present invention;

FIG. 11 is a schematic view of an assembled three-dimensional structure of the net tail according to the present invention;

FIG. 12 is a schematic view of an assembled three-dimensional structure of a second shell according to the present invention.

### DETAILED DESCRIPTION

The technical solutions in the embodiments of the present invention will be described clearly and completely in conjunction with the drawings in the embodiments of the present invention. Obviously, the described embodiments are only a part of the embodiments of the present invention, but not all the embodiments. Based on the embodiments of the present invention, all other embodiments obtained by a person skilled in the art without creative work fall within the protection scope of the present invention.

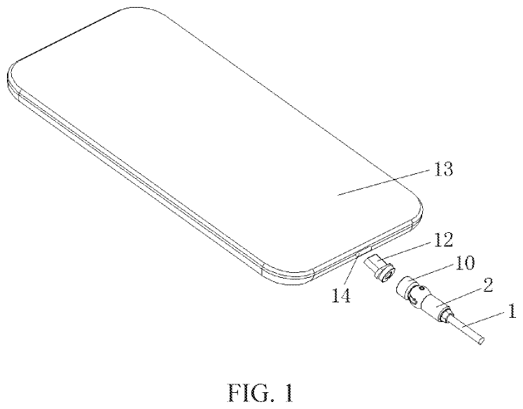

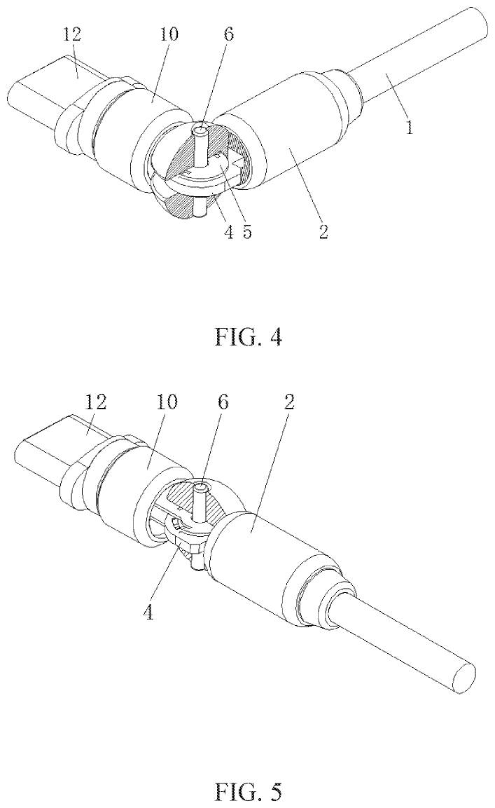

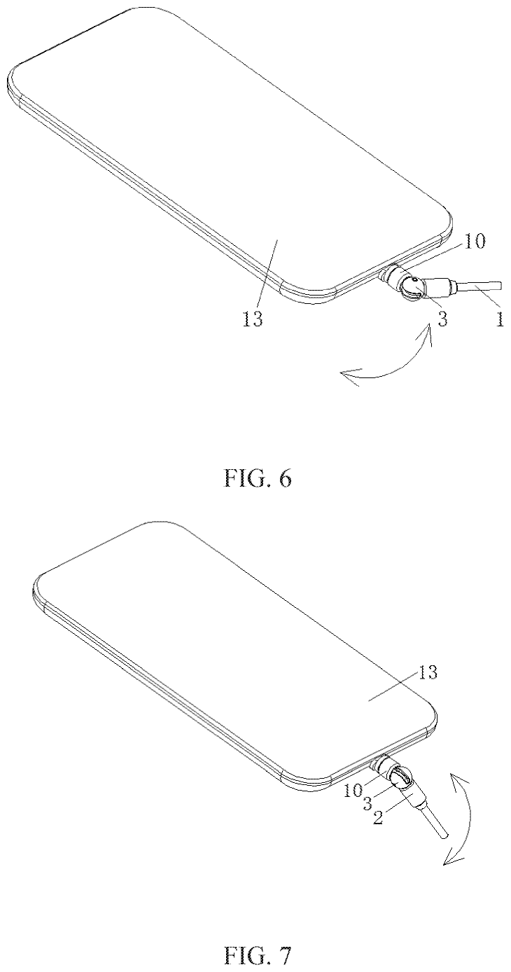

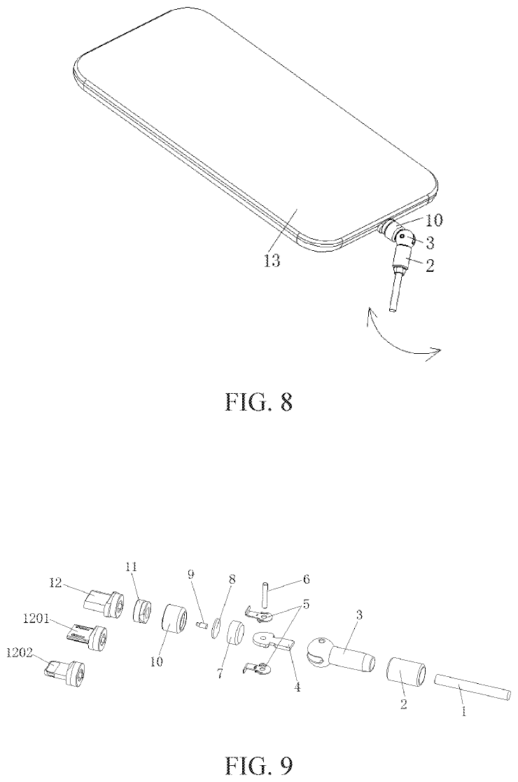

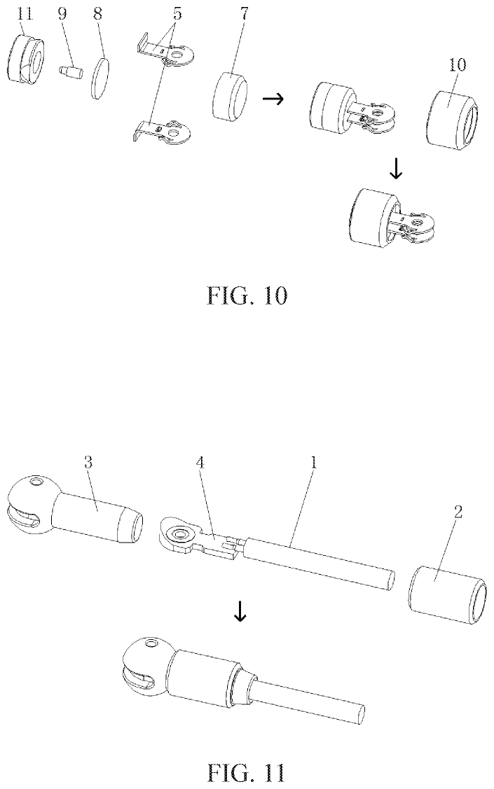

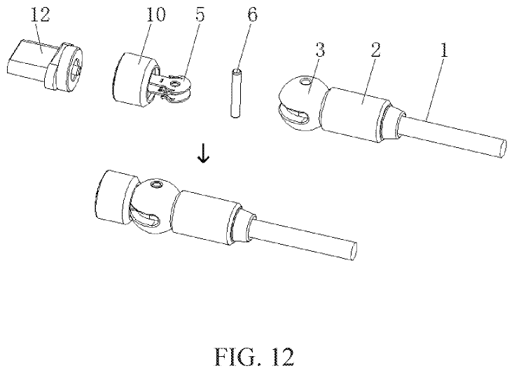

Referring to FIGS. 1-12, the present invention provides a technical solution: A spherical magnetic charging cable, including a wire 1, a first shell 2, a net tail 3, a light-emitting PCB 4, an spring plate 5, a plug shaft 6, an encapsulation 7, a PCB sheet 8, a contact spring pin 9, a second shell 10, a magnet 11, a first plug 12, a second plug 1201, a third plug 1202, a mobile terminal 13, a USB socket 14, a magnetic ring 15, a metal butt joint 16 and an arc-shaped slot 17. The first shell 2 is nested on the outer end of the wire 2, and the net tail 3 is arranged through the inside of the first shell 2, and the net tail 3 is connected with the wire 1, and the light-emitting PCB 4 is nested inside the net tail 3, and the light-emitting PCB 4 is connected to the end of the wire 1, and the outer end of the net tail 1 is provided with a magnet 11, and the contact spring pin 9 is nested at the middle end of the magnet 11, and a PCB sheet 8 is fixedly connected to the outer end of the contact spring pin 9, and a plurality of spring plates 5 are fixedly connected to the outer side of the PCB sheet 8, and the spring plates 5 are connected with the light-emitting PCB 4, and the spring plates 5 and the outer side of the PCB sheet 8 are nested with an encapsulation 7, the spring plates 5 and the middle end of the light-emitting PCB 4 are nested with a plug shaft 6, and the plug shaft 6 is connected with the net tail 3, a second shell 10 is nested on the outer side of the encapsulation 7, and the second shell 10 is connected with the magnet 11, and a first plug 12 is nested on the outer end of the magnet 11, and a mobile terminal 13 is provided on the outer end of the first plug 12, and the USB socket 14 is provided at the end of the mobile terminal 13, and at the same time, the USB socket (14) is connected to the first plug 12, and the magnetic ring 15 is fixedly connected to the outer end of the first plug 12, and an arc-shaped groove 17 is provided inside the magnetic ring 15 and the metal butt joint 16 is connected to the outer end of the first plug 12, and the metal butt joint 16 is connected to the magnetic ring 15.

The outer wrap of the wire 1 is nylon, fish wire or flash material, and the wire 1 forms a nested structure with the first shell 2 by the net tail 3, and the net tail 3 forms a rotating structure with the light-emitting PCB 4 by the plug shaft 6, and the rotation range of the net tail 3 is 0-180°. Through the nested net tail 3 and the light-emitting PCB 4, it can be stably adjusted and rotated at any angle along the outer end of the second shell 10.

The spring plates 5 are made of copper, and the spring plates 5 are symmetrically distributed about the center point of the light-emitting PCB 4, and the spring plates 5 form a nested structure with the net tail 3 and the light-emitting PCB 4 by the plug shaft 6, and at the same time, the spring plates 5 and the light-emitting PCB 4 are connected to the outer end of the PCB sheet 8 by the encapsulation 7. By using the spring plates 5 and the light-emitting PCB 4 nested by plug shaft 6, it can ensure the smoothness of the electrical docking of the device and the stability of the device's multi-angle activity.

The contact spring pin 9, the magnet 11, the magnetic ring 15 and the metal butt joint 16 are all electrodes, and the contact spring pin 9 and the metal butt joint 16 are positive poles, and the magnet 11 and the magnetic ring 15 are negative poles. When the magnet 11 is embedded in the magnetic ring 15, the metal butt joint 16 provides an electrical transfer bridge for the contact on the first plug 12 and the wire 1 by contacting the contact spring pin 9, thereby ensuring the mobile terminal 13 is normally powered by the device.

The first plug 12 is provided with a second plug 1201 and a third plug 1202, and the outer end of the first plug 12 is connected to the magnet 11, and the second plug 1201 and the third plug 1202 can be provided at the outer ends of the magnets 11, respectively. The first plug 12 and the second plug 1201 form a nested structure with the inner end of the magnet 11 by the metal butt joint 16, and the second plug 1201 and the third plug 1202 form a snap-fit structure with the mobile terminal 13 by the USB socket 14, and the mobile terminal 13 is a mobile phone or a tablet computer. The device can stably realize the docking process through three different sets of first plug 12, second plug 1201 and third plug 1202 according to different docking equipment.

An assembly process of a spherical magnetic charging cable includes the following steps:
S1: processing of the front part;
a. Put the magnet 11, contact spring pin 9, PCB sheet 8 and spring plates 5 into the metallurgical tool, then sequentially weld the magnet 11 with the contact spring pin 9 and the PCB sheet 8 together, and then weld 2 sets of spring plates 5 on the outside of the PCB sheet 8;
b. Place the welded magnet 11 and its components into the corresponding molds to form the encapsulation 7;
c. Glue the magnet 11 with the encapsulation 7 and its components to the inside of the nested second shell 10,
S2: Processing of the rear part;
a. Weld the wire 1 to the outer end of the light-emitting PCB 4;
b. Put the soldered light-emitting PCB 4 into the corresponding mold to form the encapsulation 7;
c. Nest the light-emitting PCB 4 with the encapsulation 7 and the wire 1 to the inside of the net tail 3, and then glued to the inside of the first shell 2,
S3: Total processing;
a. Fix the semi-finished product of the front part formed by the second shell 10 and the shrapnel 5 and the semi-finished product of the rear part formed by the net tail 3 and the first shell 2 together by the plug shaft 6;
b. Butt the corresponding first plug 12 with the magnet 11 inside the second shell 10 to form a finished product.

### Embodiment:

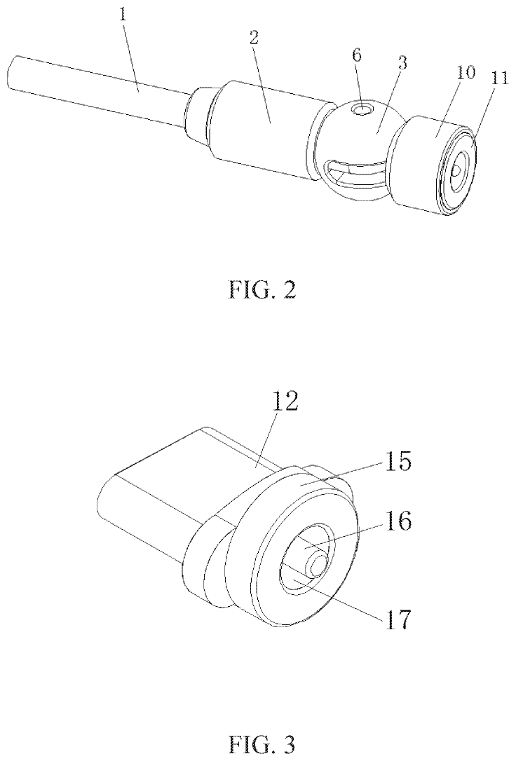

According to FIG. 1, FIG. 2, FIG. 3 and FIGS. 8-12, the device is first placed in a position where work is required, and then the user inserts the first plug 12, the second plug 1201 or the third plug 1202 into the USB socket 14 at the end of the mobile terminal 13, wherein the first plug 12, the second plug 1201, or the third plug 1202 may be one of the MIcro-usb interface, Type-c interface, 30 pin interface, or lightning interface. Next, the wire 1 to be connected is connected to the inside of the magnetic ring 15 at the end of the first plug 12 by the contact spring pin 9 inside the magnet 11. When the magnet 11 is embedded in the magnetic ring 15, the metal butt joint 16 provides an electrical transfer bridge for the contact on the first plug 12 and the wire 1 by contacting the contact spring pin 9, thereby ensuring the mobile terminal 13 is normally powered by the device.

According to FIGS. 1 and 4-8, when the user needs to adjust the angle of the wire 1, he only needs to hold the first shell 2 through the tail 3 to rotate at any angle along the outer end of the second shell 10. The light-emitting PCB 4 nested inside the net tail 3 will perform synchronous support and rotation work along the inner end of the elastic sheet 5 by the plug shaft 6. The light-emitting PCB 4 and the spring plate 5 can stably perform multi-angle rotation adjustment along the inside of the second housing 10. When rotating to a specified angle, the overall deflection angle and deflection plane of the wire 1 and the first shell 2 will also change accordingly, so as to achieve the purpose of arbitrarily adjusting the use angle of the charging cable, so that the entire wire 1 can be rotated at any angle at the junction of the net tail 3 and the second shell 10. Through the nesting and docking state between the copper spring plate 5 and the PCB sheet 8, good contact continuity is achieved, and at the same time, the wire end does not heat, ensuring the normal realization of the charging function, and ensuring that the charging cable can be bent to a specified angle at the fracture of the charging cable according to the User needs, which increases the overall practicality.

The contents that are not described in detail in this specification belong to the prior art known to those skilled in the art.

Although the embodiments of the present invention have been shown and described, it will be understood by those skilled in the art that various changes can be made to these embodiments without departing from the principles and spirit of the present invention. The scope of the invention is defined by the appended claims and their equivalents.

What is claimed is:

1. A spherical magnetic charging cable, including a wire (1), a net tail (3), a contact spring pin (9), and a metal butt joint (16), wherein a first shell (2) is nested on the outer end of the wire (1), and the net tail (3) is arranged through the inside of the first shell (2), and the net tail (3) is connected with the wire (1), and a light-emitting PCB (4) is nested inside the net tail (3), and the light-emitting PCB (4) is connected to the end of the wire (1), and the outer end of the net tail (3) is provided with a magnet (11), and the contact spring pin (9) is nested at the middle end of the magnet (11), and a PCB sheet (8) is fixedly connected to the outer end of the contact spring pin (9), and a plurality of spring plates (5) are fixedly connected to the outer side of the PCB sheet (8), and the spring plates (5) are connected with the light-emitting PCB (4), and the spring plates (5) and the outer side of the PCB sheet (8) are nested with an encapsulation (7), the spring plates (5) and the middle end of the light-emitting PCB (4) are nested with a plug shaft (6), and the plug shaft (6) is connected with the net tail (3), a second shell (10) is nested on the outer side of the encapsulation (7), and the second shell (10) is connected with the magnet (11), and a first plug (12) is nested on the outer end of the magnet (11), and a mobile terminal (13) is provided on the outer end of the first plug (12), and a USB socket (14) is provided at the end of the mobile terminal (13), and at the same time, the USB socket (14) is connected to the first plug (12), and a magnetic ring (15) is fixedly connected to the outer end of the first plug (12), and an arc-shaped groove (17) is provided inside the magnetic ring (15) and the metal butt joint (16) is connected to the outer end of the first plug (12), and the metal butt joint (16) is connected to the magnetic ring (15).

2. The spherical magnetic charging cable according to claim 1, wherein the outer wrap of the wire (1) is nylon, fish wire or flash material, and the wire (1) forms a nested structure with the first shell (2) by the net tail (3), and the net tail (3) forms a rotating structure with the light-emitting PCB (4) by the plug shaft (6), and the rotation range of the net tail (3) is 0-180°.

3. The spherical magnetic charging cable according to claim 1, wherein the spring plates (5) are made of copper, and the spring plates (5) are symmetrically distributed about the center point of the light-emitting PCB (4), and the spring plates (5) form a nested structure with the net tail (3) and the light-emitting PCB (4) by the plug shaft (6), and at the same time, the spring plates (5) and the light-emitting PCB (4) are connected to the outer end of the PCB sheet (8) by the encapsulation (7).

4. The spherical magnetic charging cable according to claim 1, wherein the contact spring pin (9), the magnet (11), the magnetic ring (15) and the metal butt joint (16) are all electrodes, and the contact spring pin (9) and the metal butt joint (16) are positive poles, and the magnet (11) and the magnetic ring (15) are negative poles.

5. The spherical magnetic charging cable according to claim 1, wherein the first plug (12) is provided with a second plug (1201) and a third plug (1202), and the outer end of the first plug (12) is connected to the magnet (11), and the second plug (1201) and the third plug (1202) can be provided at the outer ends of the magnets (11), respectively.

6. The spherical magnetic charging cable according to claim 5, wherein the first plug (12) and the second plug (1201) form a nested structure with the inner end of the magnet (11) by the metal butt joint (16), and the second plug (1201) and the third plug (1202) form a snap-fit structure with the mobile terminal (13) by the USB socket (14), and the mobile terminal (13) is a mobile phone or a tablet computer.

7. An assembly process of the spherical magnetic charging cable according to claim 1, comprising the following steps:
S1: processing of the front part;
a. Put the magnet (11), contact spring pin (9), PCB sheet (8) and spring plates (5) into the metallurgical tool, then sequentially weld the magnet (11) with the contact spring pin (9) and the PCB sheet (8) together, and then weld 2 sets of spring plates (5) on the outside of the PCB sheet (8);
b. Place the welded magnet (11) and its components into the corresponding molds to form the encapsulation (7);
c. Glue the magnet (11) with the encapsulation (7) and its components to the inside of the nested second shell (10),
S2: Processing of the rear part;
a. Weld the wire (1) to the outer end of the light-emitting PCB (4);
b. Put the soldered light-emitting PCB (4) into the corresponding mold to form the encapsulation (7);
c. Nest the light-emitting PCB (4) with the encapsulation (7) and the wire (1) to the inside of the net tail (3), and then glued to the inside of the first shell (2),
S3: Total processing;
a. Fix the semi-finished product of the front part formed by the second shell (10) and the shrapnel (5) and the semi-finished product of the rear part formed by the net tail (3) and the first shell (2) together by the plug shaft (6);
b. Butt the corresponding first plug (12) with the magnet (11) inside the second shell (10) to form a finished product.
